(19) United States
(12) Patent Application Publication
(10) Pub. No.: US 2014/0025759 A1
(43) Pub. Date: Jan. 23, 2014

(54) Alert Management System

(71) Applicant: Joe Miller, Berlin, CT (US)

(72) Inventor: Joe Miller, Berlin, CT (US)

(21) Appl. No.: 13/942,915

(22) Filed: Jul. 16, 2013

Related U.S. Application Data
(60) Provisional application No. 61/672,401, filed on Jul. 17, 2012.

(51) Int. Cl. H04L 12/58

(52) U.S. Cl. CPC H04L 51/26
USPC 709/206

(57) ABSTRACT

In accordance with the present invention, there is provided a system for monitoring device status and for forwarding service notifications to customers. The system broadly comprises a first module for downloading and storing e-mail alerts from the customer's servers, a second module for interpreting the alerts and storing the alerts for action, and a third module for creating service calls and sending e-mail notifications.

### CROSS-REFERENCE TO RELATED APPLICATION(S)

The instant applications claims the benefit of U.S. Provisional Patent Application No. 61/672, 401, filed Jul. 17, 2012, entitled ALERT MANAGEMENT SYSTEM.

### BACKGROUND

The present invention relates to an alert management system which monitors customer's imaging and printing devices for communications and activity.

### SUMMARY OF THE INVENTION

In accordance with the present invention, there is provided a system for monitoring device status and for forwarding service notifications to customers. The system broadly comprises means for downloading and storing e-mail alerts from a customer device; means for interpreting the alerts and storing the alerts for action; and means for creating service calls and sending e-mail notifications.

Further in accordance with the present invention, there is provided a process for monitoring a customer device comprising the steps of: providing a customer server associated with said customer device; sensing an issue with said customer device using said customer server; using said customer server to send an e-mail to a system server which retrieves said e-mail and interprets the issue; and using said system server to determine an action to be taken, creating a service call to correct said issue, and determining an action to be taken.

Other details of the alert management system of the present invention, as well as other objects and advantages attendant thereto, are set forth in the following detailed description and the accompanying drawings wherein like reference numbers depict like elements.

### BRIEF DESCRIPTION OF THE DRAWINGS

FIG. 1 is a schematic representation of the system of the present invention and the relationship between the components thereof;

FIG. 2 illustrates the workflow steps for the alert management system of the present invention;

FIG. 3 is a flowchart showing the imaging and/or printing device monitoring process performed by the system of the present invention;

FIG. 4 is a flowchart showing the operation of the scanner module;

FIG. 5 is a flowchart showing the operation of the decoder module;

FIG. 6 is a flowchart showing the operation of the call handler module;

FIG. 7 is a flowchart showing the operation of the heartbeat monitor module; and

FIG. 8 is a flowchart showing the consumable replenishment process.

### DETAILED DESCRIPTION

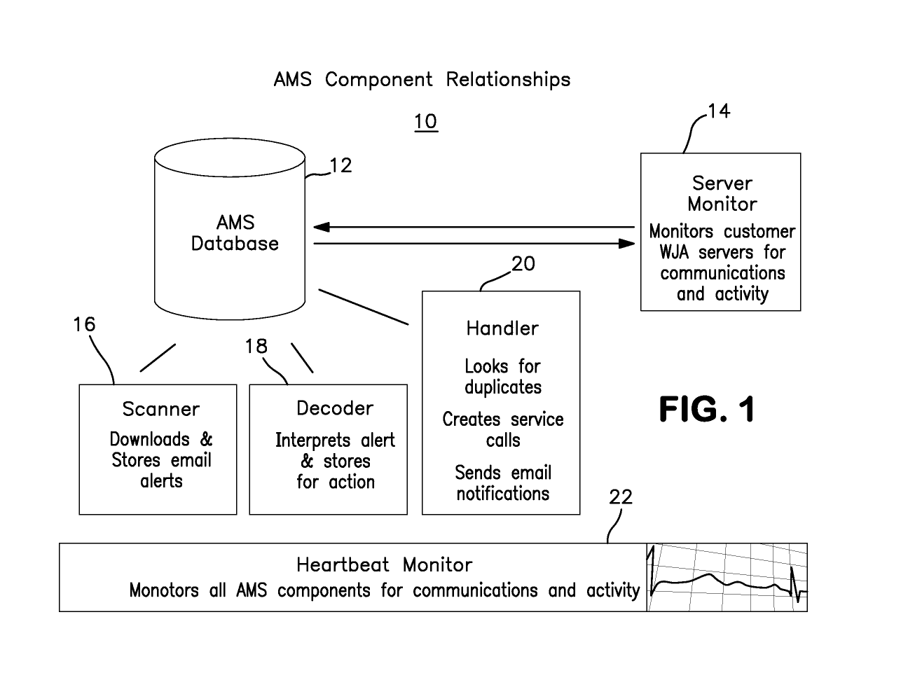

Referring to FIG. 1, there is shown a schematic representation of the alert management system 10 of the present invention. The system of the present invention while designed for and described in connection with monitoring imaging and printing devices used in offices and other commercial facilities can be used in connection with the monitoring of other devices

The alert management system (AMS) 10 includes a server 12 housing an alert management database. The server 12 communicates with, and receives communications from, a monitor 14 associated with a server on the customer's imaging and printing device(s). The server monitor 14 monitors a database to ensure that communications have been received from the customer's monitoring tool 34. This is accomplished by monitoring a table within the database. If the table has not been updated within a time frame defined for a particular customer's monitoring tool 34, an alert is triggered.

A useful embodiment of the present invention involves the server monitor 14 monitoring all communications and activities about printers, mfps, digital senders, etc. being used by each customer. The communications and activities being monitored could be, for example, communications about the status of the printers, service calls for the printers, supply needs for the printers, etc.

Within the server 12, there can be a number of modules. Each module may be implemented using a suitable service management computer program in a suitable language. For example, the server 12 may have a scanner module 16 which downloads and stores e-mail alerts, a decoder module 18 which interprets alerts and stores the alerts for action, and a handler module 20 which looks for duplicates, creates service calls, and sends e-mail notifications. The server 12 may also have a heartbeat monitor module 22 which monitors all of the modules 16, 18, and 20 and/or other components of the alert management system 10 for communications and activities.

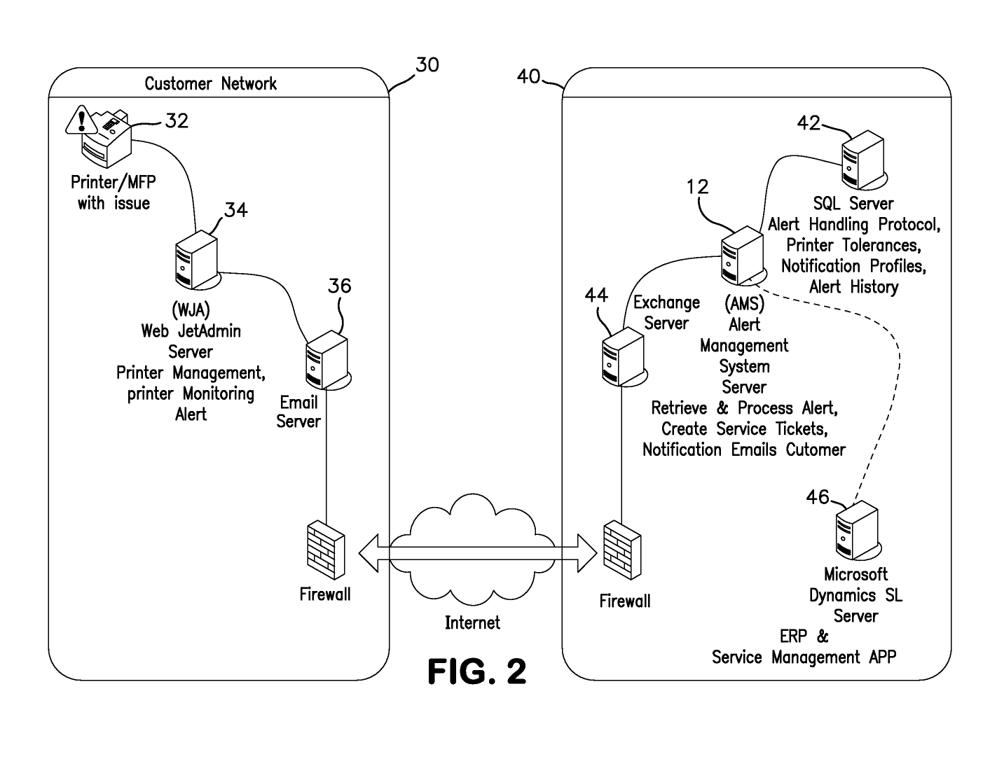

FIG. 2 illustrates the workflow steps of the alert management system 10 when used in connection with the activities of at least one device such as one or more printers. On the left hand side of the figure is illustrated a customer network 30 which has a device 32, such as a printer/MFP/digital sender, with an issue. The device 32 communicates with a device manufacturer monitoring server 34 which is used to manage and monitor communications about the device 32. The server 34 sends periodic alerts to the operator of the alert management system 10. The server 34 may communicate with an e-mail server 36 which sends out alerts and information about the status of the device 32 via the Internet.

On the right hand side of FIG. 2, there is a schematic representation of the operator network 40. The network 40 may include a database server 42 which has alert handling protocols, printer tolerances, notification profiles, and alert history stored therein. The database server 42 communicates with the alert management server (AMS) 12 containing the AMS database. The server 12 retrieves and processes alerts, creates service tickets, and sends notification e-mails to customers. The server 12 may be connected to a server 44 which receives communications from the server 36 and which sends communications to the server 36 via the Internet. The server 12 may also communicate with an operator server 46 which contains information about the operator's ERP and service management applications.

In operation, the server 34 senses an issue with the device 32. The server 34 sends an e-mail to the server 12. The server 12 retrieves the e-mail and interprets the issue. As to be described hereinafter, the server 12 determines the action to be taken, creates calls, and determines whether to notify service personnel or to do nothing at all. The server 12 takes action and records the alert and/or the action taken.

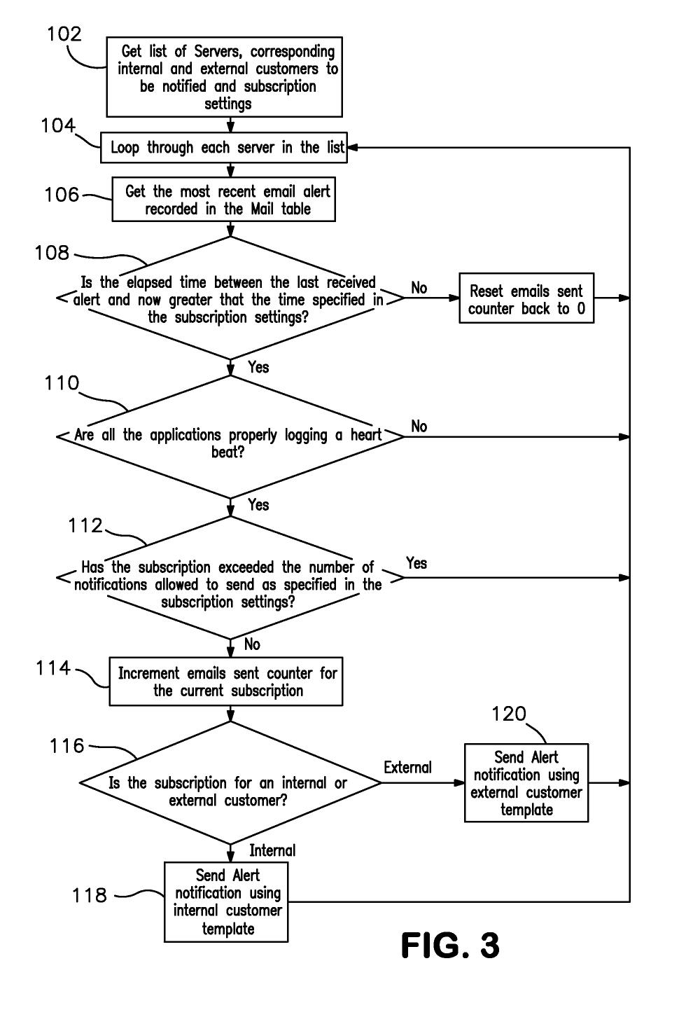

FIG. 3 is a flow chart showing the monitoring process performed by the server 12. The process is performed by a computer program in any suitable language. One of the purposes of the monitoring process is to advise internal and external parties that the device manufacturer monitoring server 34 has not sent alerts in a certain period of time. In step 102, a list of servers, corresponding to internal and external customers to be notified, and subscription settings are obtained. In step 104, each server in the list is looped through. In step 106, the server obtains the most recent e-mail alert recorded in the MailServerAlertLog table. In step 108, the following query is asked—“is the elapsed time between the last received alert and now greater than the time specified in the subscription settings”. If the answer is “no”, the e-mails sent counter is reset back to 0. If the answer is yes, then the program moves onto step 110.

In step 110, the query which is asked is—“are all the applications properly logging a heart beat”. If the answer is “no”, then the program returns to step 104. If the answer is “yes”, the program moves onto step 112. In this step, the query which is asked is—“has the subscription exceeded the number of notifications allowed to be sent as specified in the subscription settings. If the answer to this query is “yes”, the program returns to step 104. If the answer is “no”, the program moves onto step 114. In step 114, the server increments e-mails sent to the counter for the current subscription. In step 116, the program asks the query—“is the subscription for an internal or external customer.” If the answer is that it is for an internal customer, the program moves onto step 118 where an alert notification is sent to the customer using the internal customer template and thereafter, the program returns to step 104. If the answer is “external”, the program moves to step 120 and an alert notification is sent to the external customer using the external customer template. The program then returns to step 104.

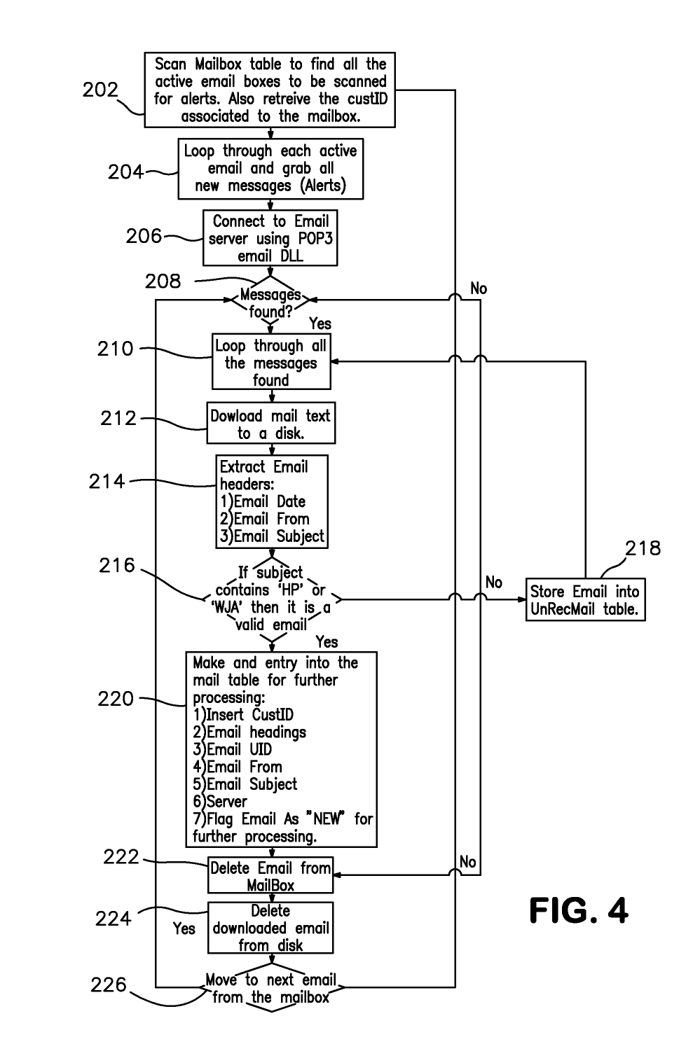

FIG. 4 is a flow chart illustrating the process for the e-mail scanner module 16. In step 202, the module scans the mailbox table maintained in the database in the server 12 to find all the active e-mail boxes to be scanned for alerts. The module also retrieves the customer ID associated with each mailbox. In step 204, the module 16 then loops through each active e-mail box and grabs all new messages (alerts). In step 206, the module 16 connects to the e-mail server(s) using POP3 e-mail DLL. In step 208, the module 16 checks to see if any messages have been found. If the answer is “no”, the module goes to step 222. If the answer is “yes”, the module goes to step 210.

In step 210, the module 16 loops through all the messages that were found. In step 212, the module 16 downloads the mail text to a disk. The module 16 may make use of different algorithms to download all possible mail text formats and attachments. In step 214, the module extracts e-mail headers such as e-mail date, e-mail from, and e-mail subject. In step 216, the module 16 ascertains whether the subject contains HP or device manufacturer monitoring software. If subject contains one of these indicators, it is a valid e-mail. If the subject does not contain one of these indicators, the module 16 goes to step 218, where the e-mail is stored in a table designated as a UnRecMail table.

In step 220, an entry is made into the mail table for further processing such as insert customer ID, e-mail headings, e-mail UID, e-mail from, e-mail subject, server, and/or flag e-mail as new for further processing.

In step 222, e-mail is deleted from the mailbox. In step 224, downloaded e-mail is deleted from the disk. In step 226, the module 16 inquires whether it should move to the next e-mail from the mailbox. If the answer is “no”, the module returns to step 204. If the answer is “yes”, the module returns to step 210.

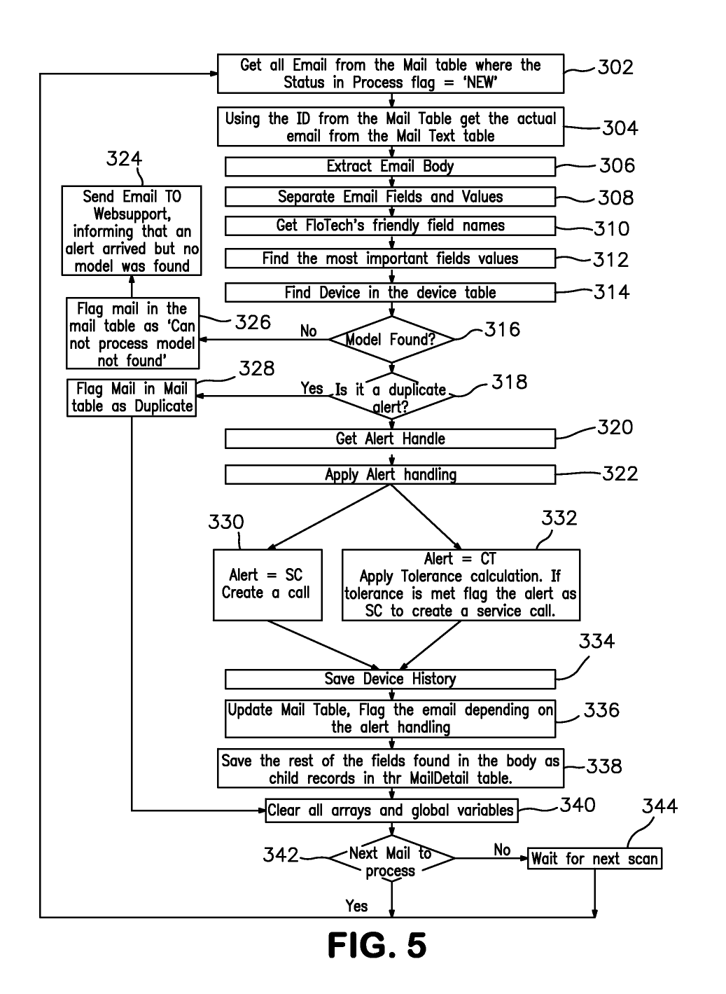

FIG. 5 illustrates the e-mail decoding process performed by the decoder module 18. In step 302, the module 18 retrieves all e-mails from the mail table where the status in process flag equals “new”. In step 304, using the ID from the mail table, the module 18 gets the actual e-mail text from the mail text table. In step 306, the e-mail body is extracted. In step 308, the e-mail is separated into fields and values. The fields may be the customer ID or a customer address. The field values may be a series of assigned numbers. In step 310, the module 18 obtains the operator's friendly field names. In step 312, the module 18 finds the most important field values such as alert, serial #, MacAddr, IP address, and/or model. The important values identified in step 312 are validate, and the IP address obtained is passed through an industry standard IP address validation algorithm. The serial number from the mail text is verified that it is not part of the exception list in the SerialException table. In step 314, the module 18 finds the device 32 in a device table. In this step, the module 18 goes to the device table and finds the device 32 where the serial # and customer ID exist. If the device 32 is found, the module 18 obtains the device ID. If the device 32 is not found, then it is added to the table with the fields.

In step 316, the module 18 inquires whether the model has been found. If the answer is “no”, the module program goes to step 326 where the e-mail is flagged in the e-mail table as “can not process model not found.” The program for the module 18 then goes on to step 324, where an e-mail to websupport is sent informing that an alert arrived but no model was found. If the answer to the inquiry in step 316 is “yes”, the program inquires whether it is a duplicate alert. If the answer is “yes”, the program moves to step 328 where the e-mail is flagged in the mail table as a duplicate. The mail table may record the following data: alert, customer ID, device ID, e-mail date, mail table ID, model, page count, serial #. If the answer is “no”, the program moves to step 320 where an alert handle is obtained. Alert Handling is determined by first looking at the account specific setup. An account could be set up to just ignore the alert, to send email notifications only, to create service calls only and/or to send notification and create service calls. Once the process flags are considered the alert handling is determined by looking at a hierarchy of the table to see if a specific alert handle has been set for the specific meter type (mono or color) and equipment/device 32. If a record is not found in any of the tables, then default alert handles can be used. The hierarchy may be the serial #, model, site, customer ID, and defaults. The alert handles may be designated SC (create service call), SO (supply order), and/or CT (perform calculation). When the device 32 is a printer, the CT designation is mostly used for paper jams. Based on history and page counts, some thresholds may be set and when the thresholds are met, a call may be created.

In step 322, the module 18 applies the alert handling. In step 330, an SC alert has been created. In step 332, a CT alert has been used to create a service call. In step 334, the device history is saved. In step 336, the mail table is updated and the e-mail may be flagged depending on the alert handling. In step 338, the rest of the fields found in the body as child records are saved in the Mail Detail table. In step 340, all arrays and global variables are cleared. In step 342, the next e-mail is processed by returning to step 302. If there is no e-mail to be processed, the program moves to step 344 and waits for the next scan.

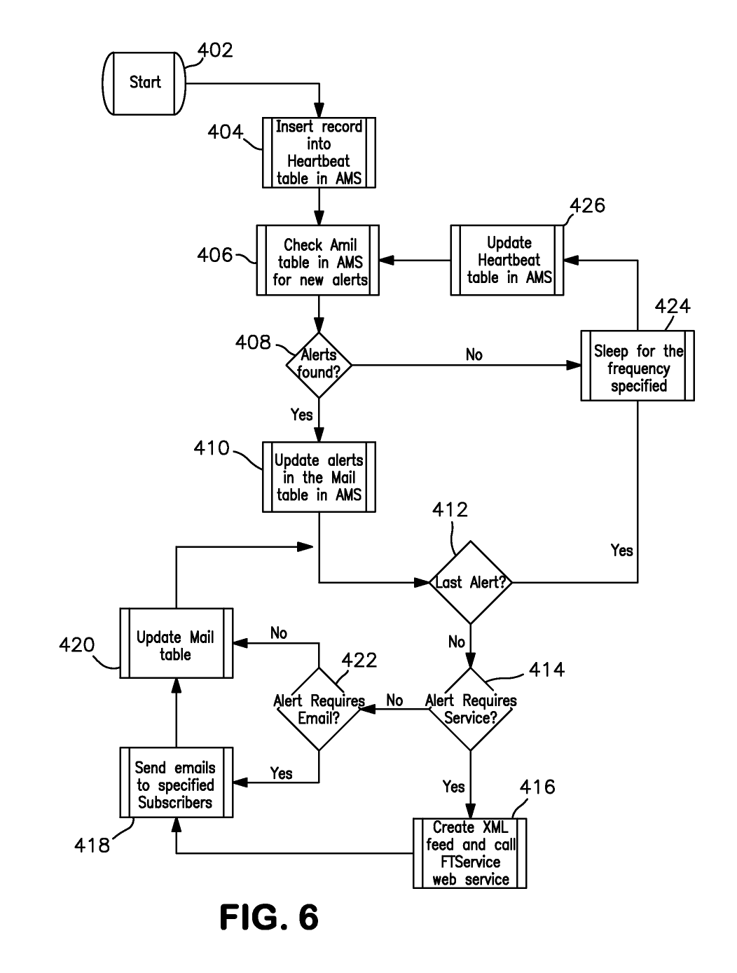

Referring now to FIG. 6, there is shown the process performed by the Call Handler module 20. The purpose of the call handler module process is to react to alerts discovered by the AMS system based on what action the E-mail Decoding Process has defined. The system will either ignore the alert, send out email notifications to subscribers, or create service calls within a Service Dispatch system.

The process starts in step 402 based on a defined schedule, e.g. every 5 minutes. In step 404, the record is inserted into the Heartbeat Table in the AMS. The entry is monitored by the heartbeat monitor 22 application. In step 406, the mail table is checked in the AMS for new alerts that have been identified by the e-mail decoder application as requiring service or e-mail notification. In step 408, the program determines whether any alerts have been found. If the answer is “no”, the program goes to step 424 where the program goes to sleep for the specified period/frequency. The program then goes to step 426 where the heartbeat table is updated by checking in with the table so that the Heartbeat Monitor application knows that it is still running. If the answer to the query in step 408 is “yes”, the alerts in the Mail table are updated. The alerts which are updated are those that require processing so that another instance of this application will re-process them. In step 412, the program inquires “was this the last alert?” If the answer is “yes”, the program goes to step 424. If the answer is “no,” the program moves on to step 414. In step 414, the program inquires whether the alert requires service. If the answer is “yes”, the program moves to step 416 to create an XML feed and call FTService web service. The XML feed is tied to the service dispatch system which generates a service call. Thereafter, in step 418, e-mails are sent to specified subscribers to notify them of the alert and the action taken if any. Following transmission of the e-mails, the mail table is updated in step 420 and the program returns to step 412.

If in step 414 if the answer to the inquiry is “no”, the program moves onto step 422 where it inquires as to whether the alert requires e-mail. If the answer is “yes”, the program moves to step 418. If the answer to this query is “no”, then the program moves to step 420.

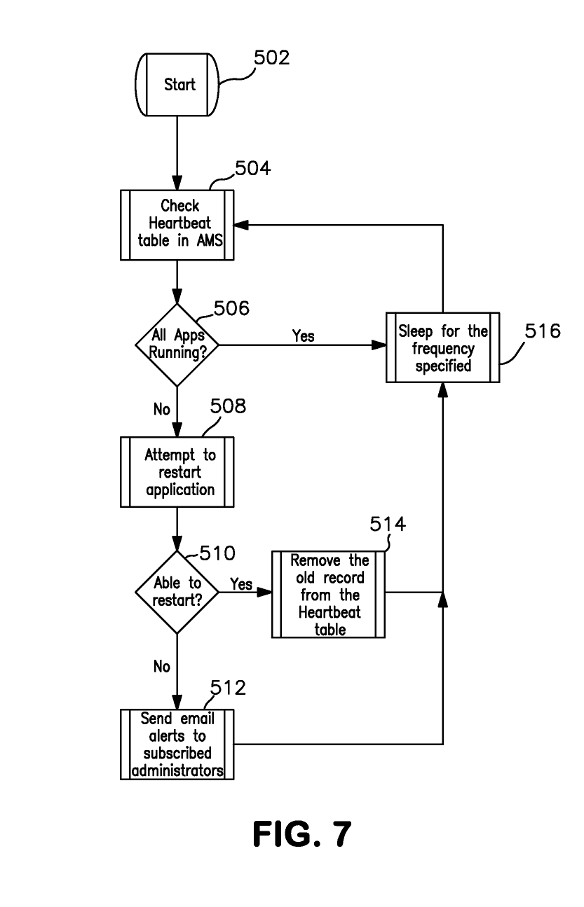

FIG. 7 illustrates the heartbeat monitoring flowchart for the module 22. The purpose of the heartbeat monitoring process is to make sure that all of the AMS applications are functioning. It does so by checking a table in the AMS database in the server 12 that the applications check-in with on a regular basis. If any of the applications have not checked-in for a certain period of time, the heartbeat monitor process sends out e-mail alerts to notify system administrators who then restart the application that has failed.

The heartbeat monitoring process begins at step 502 where the application starts based on a defined schedule, e.g. every 5 minutes. In step 504, the heartbeat table in the AMS is checked to make sure that all applications have checked in within a specified time frame, e.g. within the past 5 minutes. In step 506, the process raises the query are all applications running. If the answer is “yes”, the process goes to step 516 where it goes to sleep for a specified frequency/period. If the answer to the query is “no”, the process moves onto step 508. In this step, the process attempts to restart the application. In step 510, the process queries whether the process was able to restart. If the answer to this query is “yes”, the process moves on to step 514. In this step, the record in the heartbeat table in the AMS for the application that failed is removed, so it does not continue to get picked up by the Heartbeat Monitor 22. If the answer to the query in step 510 is “no”, the process moves on to step 5112. In this step, e-mail alerts are sent to administrators who have subscribed to the Heartbeat Monitor alerts.

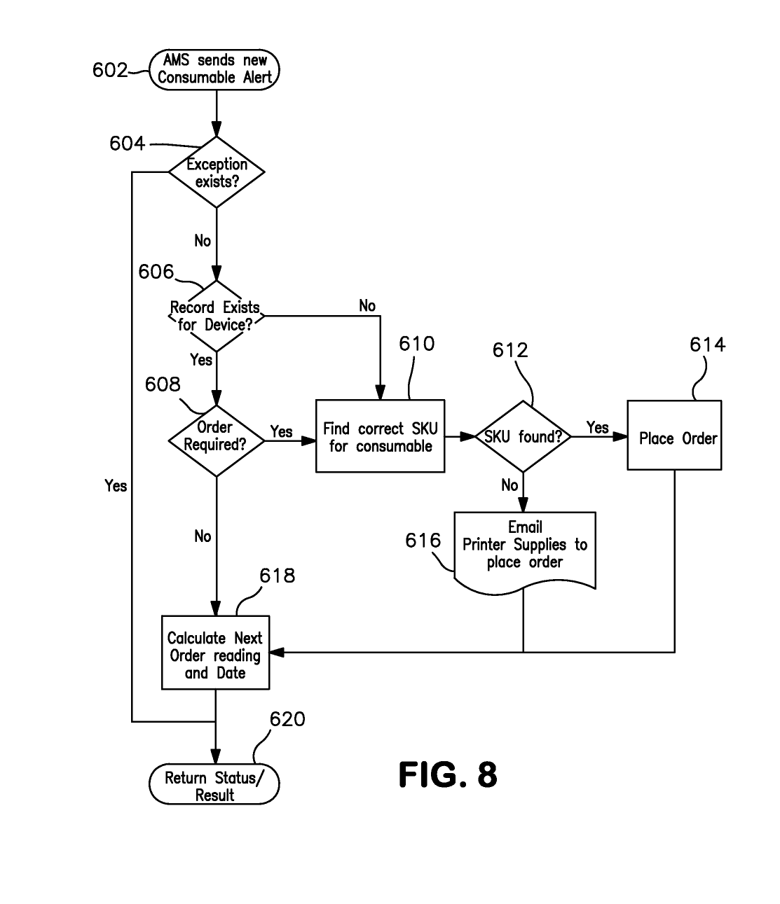

FIG. 8 illustrates the Consumable replenishment process. In step 602, the process checks for new consumable alerts in the mail table. Information retrieved from the table includes, but is not limited to, Equipment ID, consumable type, page count, and/or meter type (color or mono). In step 604, the process checks if there are exceptions for the equipment in the xftCnsmblExec table. The process can be configured to exclude customer, equipment, model and consumables from automatic consumable replenishment. If exceptions are found, the process exits in step 604 and takes no action. In step 606, the process looks for consumable history entries in the xftCnsmlHist table. If the answer is “yes” for step 606, the process proceeds to step 608. If the answer is “no” in step 606, the process proceeds to step 610. Step 608 looks to determine if a consumable order is required by comparing the current reading or current date to the stored anticipated order date/reading for the equipment/consumable type. If the answer for step 608 is “yes”, the process proceeds to step 610. If the answer for step 608 is “no”, the process then proceeds to step 618. In step 610, the process applies logic to determine the correct SKU for the consumable. Step 612 checks if the SKU for the consumable was found. If the answer is “yes”, the process proceeds to step 614. If the answer is “no”, the process proceeds to step 616. In step 614, the process places the order by inserting a record in the xftCnsmblOrds. In step 616, an email is sent to the orders department to manually place the order and for the accounting department to update the SKU definition for consumables where the SKU for the device/consumable type was not found. In step 618, the new consumable information is used to forecast a new replenishment page count and date for the next expected consumable replenishment. Step 620 completes the replenishment process by returning an order number or a “no action” value.

While numerous components/modules of the alert management system 10 have been described, the system 10 could have other components/modules which carry out additional functions. For example, additional notification modules and methods which monitor and utilize communication devices such as SMS, fax, pagers and RSS feeds could be present. Customer customization notification text modules based on the alert type can be provided. These modules would allow the customer to setup instructions specific to them based on the alert received and the person receiving the notification. An example may be giving specific instructions as to how to obtain a toner cartridge from an internal supply when a toner low happens or how to dispose of an empty cartridge. A module may be provided which has the capability to allow a user to click on a URL within a notification that automatically creates a service call for the device in question utilizing the known alert and device data. A module may be provided which allows scheduling of automated reports regarding the customer's population and their alert management system activity. A module may be provided which triggers reporting based on milestones or metrics being met, e.g. sending a notification when a printer reaches 1,000,000 pages or when monthly volume goes over 15,000 pages. A module can be provided which notifies subscriptions with an expiration date. Usage here could be for customers with a temporary sensitivity to a certain type of error. They could set up a subscription with an expiration date so that they could be notified of a particular type of error occurring that they normally would not be interested in. The module could be used perhaps when a new firmware revision is loaded, a new application patch is applied, a print driver is changed or recent service was performed—all to watch for issues related to those events.

There could also be supply handling enhancements to the system 10. For example, there could be a module with the capability to automatically and intelligently replenish customer supplies utilizing such variables as: determining whether the device is using a high yield or low yield cartridge when estimating time of actual replenishment needed; utilizing a percentage of cartridge yield to leave room for error when estimating time of actual replenishment needed; utilizing average page coverage when estimating time of actual replenishment needed; and/or utilizing device volume (i.e. run rate) based on previous alerts when estimating time of actual replenishment needed. The module could include time to ship estimates based on known device location data when estimating time of actual replenishment needed.

There could be a module with the capability to automatically replenish customer supplies and satisfy all logistical needs for both the operator of the alert management system and the customer including: (1) whether the customer utilizes centralized fulfillment (e.g. stock room) vs. de-centralized fulfillment (e.g. end user); for customers that require approving purchases, an automatic notification to them indicating that an order is ready, which needs their approval to be released which could include a URL to release the order; automatic replenishment to connecting shipping address and location determined by known alert and device data; and/or when allowed by customer, automatic batching (or aggregation) of items needed into fewest orders possible within a set period of time by customer and shipping location, e.g. tally all toner low alerts received for a once weekly shipment for replenishment.

The system may also have device handling capabilities such as a web portal with capabilities to manage fleet data such as demographical data which includes associated end user, purchase information, value, etc. and/or manage alert subscriptions (which ones; who gets them). A web portal may be provided with capabilities to review statistics regarding fleet for things like: alerts received by category, serial number, group, device type, or any combination thereof; page volume by serial number, group, device type, etc; and/or highlight significant trends in population, i.e. highest number of alerts, highest/lowest usage, average time to clear errors, and new devices or missing devices. A module can be provided which provides automatic notification to a customer when new devices are discovered along with an inquiry regarding how that device is to be handled (e.g. would you line to add it to the contract). A module could be provided which takes note of devices that have had service recently and which provides special handling that would make alerts from them have a higher priority, triggering creation of a service call when one would not typically be created. This would be akin to putting the device on a watch list or intensive care.

Still further, the system 10 could have a module which automatically notifies the customer when a device may be a candidate for replacement. Variables that could be taken into account include: rated print volume for a device having been exceeded; jamming patterns for a device that suggests replacement; devices with error patterns that are outside the norm for their population; older models with reduced capabilities in comparison to newer models; and/or the identification of devices that lack regular usage, which may indicate that device is not adequate for needs. The module could automatically suggest the proper replacement for a device using known statistics from historical alert management system data (e.g. volume, error rate, device capabilities, etc.).

It is apparent that there has been provided herein an alert management system which fully satisfies the objects, means and advantages set forth hereinbefore. While the system has been described in the context of specific embodiments thereof, other unforeseeable alternatives, modifications, and variations may become apparent to those skilled in the art having read the foregoing description. Accordingly, it is intended to embrace those alternatives, modifications, and variations.

What is claimed is:

1. A system for monitoring device status and for forwarding service notifications to customers, said system comprising:
means for downloading and storing e-mail alerts from a customer device;
means for interpreting the alerts and storing the alerts for action; and
means for creating service calls and sending e-mail notifications.

2. The system of claim 1, wherein said means for downloading and storing e-mail alerts comprises:
a system server housing an alert management database;
a customer server associated with said device;
a monitor associated with said customer server; and
said system server communicating with and receiving communications from said monitor.

3. The system according to claim 2, wherein said monitor monitors a database to ensure that communications have been received from the customer.

4. The system according to claim 1, wherein said customer device comprises one of a printer, an imaging device, mfps, and digital sender.

5. The system according to claim 2, wherein said system server includes at least one of a scanner module for downloading and storing e-mail alerts, a decoder module for interpreting alerts and storing the alerts for action, a handler module which looks for duplicates, creates service calls, and sends e-mail notifications, and a monitor module for monitoring said scanner module, said decoder module, and said handler module.

6. The system according to claim 5, wherein said means for interpreting the alerts and storing the alerts for action comprises said decoder module.

7. The system according to claim 5, wherein means for creating service calls and sending e-mail notifications comprises said handler module.

8. The system according to claim 2, wherein said customer server comprises a monitoring server which communicates with an e-mail server for sending out alerts and information about the status of the customer device.

9. A process for monitoring a customer device comprising the steps of:
providing a customer server associated with said customer device;
sensing an issue with said customer device using said customer server;
using said customer server to send an e-mail to a system server which retrieves said e-mail and interprets the issue; and
using said system server to determine an action to be taken, creating a service call to correct said issue, and determining an action to be taken.

10. The process of claim 9, wherein said action determining step comprises determining to take no action at all.

11. The process of claim 9, wherein said action determining step comprises notifying service personnel.

12. The process of claim 9, further comprising determining whether the customer server has not sent alerts in a certain period of time.

13. The process of claim 9, further comprising determining whether a customer subscription has exceeded the number of notifications allowed.

14. The process of claim 9, further comprising sending an alert notification to a customer.

15. The process of claim 9, further comprising saving a service history of the customer device.

16. The process of claim 9, further comprising periodically checking all applications and determining that all applications have been checked.

17. The process of claim 9, further comprising checking for consumable alerts and determining an action to be taken or not taken with respect to consumables from said consumable alerts.

18. The process of claim 17, wherein said action determining step comprises placing an order for said consumables.
